(19) United States
(12) Patent Application Publication
(10) Pub. No.: US 2025/0109826 A1
(43) Pub. Date: Apr. 3, 2025

(54) METHOD AND DEVICE FOR DETECTING ANY THROTTLING LOSSES IN A HYDROGEN TANK SYSTEM

(71) Applicant: Robert Bosch GmbH, Stuttgart (DE)

(72) Inventors: Adam Pawlowski, Stuttgart (DE); Sonny Tran, Stuttgart (DE)

(21) Appl. No.: 18/730,055

(22) PCT Filed: Dec. 15, 2022
(86) PCT No.: PCT/EP2022/086226

§ 371 Date: Jul. 18, 2024

(30) Foreign Application Priority Data
Jan. 18, 2022 (DE) 10 2022 200 492.2

(51) Int. Cl. F17C 13/02

(52) U.S. Cl. CPC F17C 13/025; F17C 13/026; F17C 2221/012; F17C 2250/0408; F17C 2250/043; F17C 2250/0439; F17C 2260/03; F17C 2270/0178

(57) ABSTRACT

A method (40) for detecting any throttling losses (11) in a hydrogen tank system (10),
characterized by the following features:
   before access to the hydrogen tank system (10), a course (30) of pressure and temperature (31) expected for the access without the throttling losses (11) is determined at different measuring points in the hydrogen tank system (10),
   the pressure and the temperature (31) at the measuring points are continuously recorded during the access, and
   the throttling losses (11) are detected on a case-by-case basis on the basis of the deviation (33) of the pressure or the temperature (31) from the expected course (30).

### BACKGROUND

The present invention relates to a method for detecting any throttling losses in a hydrogen tank system. The present invention also relates to a corresponding device, a corresponding computer program, and a corresponding machine-readable storage medium.

A hydrogen filling station has fuel pumps, nozzles, and pumps that can be used to replenish the energy supply of fuel cell vehicles or other mobile hydrogen consumers. In the prior art, for example, liquid hydrogen (LH₂) is offered at a temperature of up to −253° C. and a pressure of up to 16.5 bar and gaseous hydrogen (GH₂) at a temperature of 20° C. and a pressure of 250 or 350 bar or a temperature of −40° C. and a pressure of 700 bar.

DE102019219826A1 relates to a method for refueling a vehicle with a hydrogen tank containing gaseous hydrogen. The method is carried out in the following method steps: The vehicle enters a refueling area. A refueling step is carried out on the vehicle. An initial tank temperature check is then carried out on the contents of the at least one hydrogen tank. If the temperature of the tank contents of the at least one hydrogen tank exceeds a temperature limit, the vehicle is transferred to a cool-down area. After a cooling phase, a second tank temperature check is carried out there. If the tank temperature is below a temperature limit, the tank pressure is checked. If the tank pressure in the at least one hydrogen tank is below a tank pressure limit value, the vehicle is transferred to the refueling area for further refueling; if the tank pressure is within the tank pressure limit value, refueling ends.

### SUMMARY

The invention provides a method for detecting any throttling losses in a hydrogen tank system, a corresponding device, a corresponding computer program, and a corresponding storage medium according to the disclosure.

The proposed solution is based on the realization that storing gaseous hydrogen on board vehicles is significantly more complex than storing an equivalent quantity of liquid hydrocarbons. Hydrogen tank systems known from the prior art therefore generally comprise several tanks and are correspondingly complex and expensive.

The approach according to the invention also makes use of the fact that each tank is typically equipped with a temperature sensor to provide information about the amount of hydrogen stored. In addition, the pressure is usually measured at several points in the tank system, although usually not in every tank.

Furthermore, the process described below takes into account the fact that a fuel cell is often used to convert energy in hydrogen-powered vehicles. This process is characterized by a higher degree of efficiency than a combustion engine; however, fuel cells place high demands on the purity of the hydrogen supplied to ensure their long-term functionality.

Various filters are therefore used in hydrogen tank systems. The latter throttle the hydrogen flow rate to a certain extent, even when functioning perfectly. They can also become clogged and impair the function of the tank system. However, clogged filters are just one example of undesirable throttling points in hydrogen tank systems. Other throttling losses can result from the fact that such systems are used in harsh environments in commercial vehicles, e.g., in mining or construction sites. In such environments, hydrogen pipes in the system can be unintentionally deformed in such a way that they become a significant throttling point. In addition to the examples mentioned, there are also many other possible causes of undesirable throttling points in the tank system.

The diagnosis of throttling losses is made more difficult by the fact that maintenance work on hydrogen tank systems is inherently dangerous due to the dangers posed by hydrogen and should therefore be avoided wherever possible. A method for detecting and limiting undesired throttling points during normal operation is therefore desirable.

In view of this task, the proposed solution is based on the insight that throttling losses affect the pressure and temperature of the hydrogen in the tank system depending on the position of the unwanted throttling point during refueling and withdrawal. Based on the pressure and temperature courses recorded at different measuring points in the tank system, the throttling loss within the system can thus be localized—knowing the pipe connections between these measuring points.

One advantage of this solution is that it opens up the possibility of detecting unwanted throttling points within a closed hydrogen tank system during regular operation.

The measures listed in the dependent claims enable advantageous further developments and improvements of the basic idea stated in the independent claim. For example, the tanks affected by the throttling losses can be taken out of service at least temporarily in order to avoid dangerous interactions between the tanks when accessing the system.

### BRIEF DESCRIPTION OF THE DRAWINGS

Exemplary embodiments of the invention are shown in the drawings and explained in more detail in the following description. Shown are:

FIG. 1 The system diagram of a hydrogen tank system.

FIG. 2 a temperature course in side and rear tanks without throttle.

FIG. 3 the corresponding temperature course in side and rear tanks with throttle.

FIG. 4 the flow chart of a method according to a first embodiment.

FIG. 5 schematic of a control unit according to a second embodiment.

### DETAILED DESCRIPTION

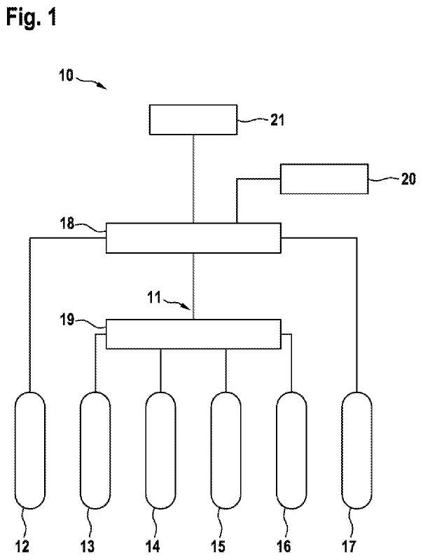

FIG. 1 illustrates a hydrogen tank system (10). In principle, undesirable throttling points can affect this system in two ways: firstly during refueling and secondly during hydrogen withdrawal from the tank system.

The refueling process will be considered first: Here, the hydrogen in each filled tank (12-17) heats up, which is detected by its temperature sensor. However, any throttling losses in the system (10) slow down the rise in pressure and consequently the rise in temperature. With several measuring points, this allows conclusions to be drawn about the throttling point, as explained below using the hydrogen tank system (10) shown.

If the undesired throttling point is located between the intake (20) and the first downstream branch (18) to the individual tanks (12-17), it slows down the filling of all tanks (12-17) equally. This manifests itself in an overall slower pressure increase in the hydrogen tank system (10) compared to a system without throttling losses and can therefore be observed equally in a delayed pressure increase at the pressure measuring points or a slower delayed temperature increase at the temperature measuring points of all tanks (12-17).

If the undesired throttling point is located between a tank and the branch immediately upstream of it in terms of fluid technology—in the configuration shown, for example, between the upper branch (17) and the left side tank (12) as shown in the illustration—only this tank (12) is affected by the slowed pressure build-up. If a pressure sensor is provided there, the delayed pressure rise can be measured directly, otherwise it can at least be derived from a slower temperature rise in the tank (12).

In the event of a throttling loss at the throttling point marked with the reference sign 11 between the branches (18, 19) to the side (12, 17) and rear tanks (13-16), only the latter are affected by the delayed pressure increase, while the pressure in the side tanks (12, 17) follows the expected course. If pressure sensors are installed in the tanks (12-17) of both tank groups, this effect can also be measured directly. In this case, too, the temperature in certain tanks (12-17) can be used as a substitute for the pressure conditions prevailing in them.

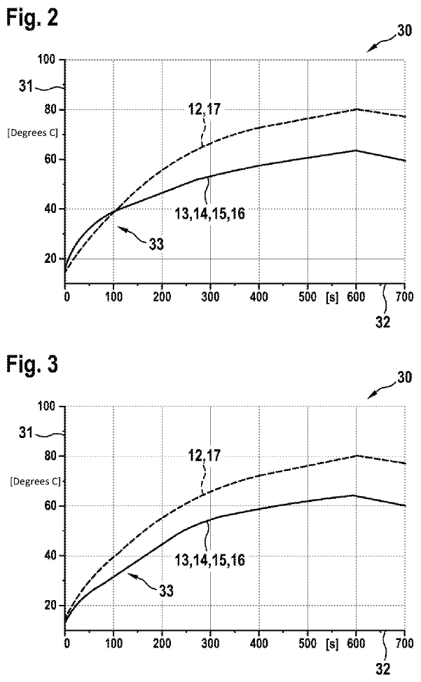

FIG. 3 shows an example of the time course (30) that the temperature (31) takes at the said point in the event of a throttling loss (11). A comparison with the course (30) expected without the throttling loss (11) as shown in FIG. 2 makes it clear that the temperature (31) in the rear tanks (13-16) rises much more slowly (33) due to the throttling. However, as the combined view of FIGS. 2 and 3 shows, the throttling loss (11) does not significantly affect the course (30) of the temperature (31) in the side tanks (12, 17).

Now the withdrawal of the hydrogen from the tank system (10) will be considered: Here the pressure in the tanks (12-17) drops, which leads to a decrease in temperature due to the isochoric expansion of their contents. However, the hydrogen mass flow rates during withdrawal from the tank system (10) are typically much lower than the mass flow rates during refueling. The temperature (31) therefore decreases correspondingly slowly, which makes it difficult to reliably detect throttling losses in this application. During the withdrawal of hydrogen from the tank system (10), the detection should therefore preferably be carried out in phases of increased mass flow, for example during longer highway journeys in a hydrogen-powered road vehicle.

According to the above explanations, throttling losses during the emptying of the hydrogen tank system (10) therefore do not delay the rise but rather the fall in temperature (31). However, this circumstance also allows conclusions to be drawn about the throttling point in the case of several measuring points, as can be seen from the following considerations.

If the unwanted throttling point is located between the upper branch (18) and the pressure reducer (21), as shown in the figure, it reduces the pressure detected there. The extent of this pressure drop depends on the mass flow extracted. In the event of severe throttling, the tank system (10) can no longer supply the desired mass flow, although the tank pressure required for this would still be achieved with unrestricted function. In this case, a significant pressure difference between the pressure reducer (21) and the other pressure measuring points as well as a delayed temperature drop at the temperature measuring points in all tanks (12-17) can be determined.

If the undesired throttling point is located between a tank and the branch immediately upstream of it in terms of fluid technology—in the configuration shown, for example, between the upper branch (17) and the left side tank (12)—only this tank (12) is affected by the slowed pressure drop. If a pressure sensor is present there, this delayed pressure drop can be measured immediately, otherwise derived from a slower temperature drop in the tank (12).

In the event of a throttling loss at the throttling point marked with the reference sign 11 between the branches (18, 19) to the side (12, 17) and rear tanks (13-16), only the latter are affected by the delayed pressure drop, while the pressure in the side tanks (12, 17) follows the expected course. If pressure sensors are installed in the tanks (12-17) of both tank groups, this effect can also be measured directly. In this case, too, the temperature in certain tanks (12-17) can be used as a substitute for the pressure conditions prevailing in them.

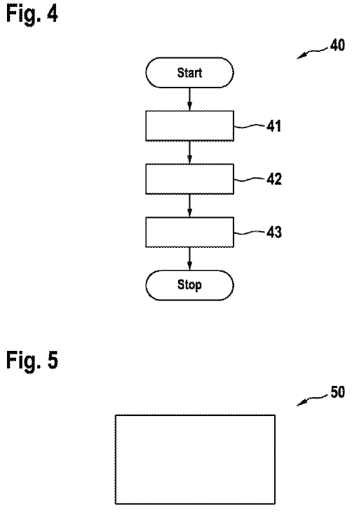

A concrete implementation of this process (40) is now explained with reference to FIG. 4. When accessing the hydrogen tank system (10), the pressure and temperature (31) course (30) that would be expected without throttling losses (process 41) is first determined specifically for each of the tanks (12-17). The initial temperature and fill level of the individual tanks (12-17) are taken into account here, as well as the total mass flow removed during withdrawal and the ambient temperature of the hydrogen tank system (10).

During access, pressure and temperature (31) are then continuously recorded at the various measuring points (process 42). Deviations from the course (30) expected for the respective tank (12-17) can thus be easily determined. For example, a deviation (33) can be assumed if the pressure or temperature (31) fails to reach a predefined threshold value even after a certain period of time or if the respective measured variable increases (when filling) or decreases (when emptying the hydrogen tank system) less than expected.

The deviation (33) detected in this way indicates a throttling loss, which can be narrowed down to specific pipe sections on the basis of the measuring points affected by it as described above. Throttling losses detected in this way are therefore noted in a fault memory, indicating the throttling point in question, or displayed to the operator of the hydrogen tank system (10)—such as the driver of a motor vehicle equipped with it.

Reliable detection can only be achieved with a strong undesirable throttling effect. If this occurs in the system (10), there may be significant pressure differences between the tanks (12-17) during refueling and withdrawal. These pressure differences can lead to certain tanks (12-17) being filled from other tanks (12-17), especially during commissioning of the system (10) after the tank valves have been opened. Such interactions between the tanks (12-17) are dangerous as they can only withstand a limited number of refueling operations due to the considerable tank pressure.

To avoid such effects, individual tank containers affected by throttling losses can be deactivated temporarily or permanently, for example by excluding their tank valves from activation during commissioning of the tank system (10). In a hydrogen-powered vehicle, this component protection measure is taken at the cost of a reduced range, which may again be communicated to the driver via a suitable human-machine interface.

This method (40) can, for example, be implemented in software or hardware or in a hybrid form of software and hardware, for example in a control unit (50), as illustrated in the schematic diagram in FIG. 5.

1. A method (40) for detecting any throttling losses (11) in a hydrogen tank system (10),
the method comprising:
before access to the hydrogen tank system (10), determining, at different measuring points in the hydrogen tank system (10), a course (30) of pressure and temperature (31) expected for the access without the throttling losses (11),
recording the pressure and the temperature (31) at the measuring points continuously during the access, and
detecting the throttling losses (11) on a case-by-case basis of the deviation (33) of the pressure or the temperature (31) from the expected course (30).

2. The method (40) according to claim 1,
wherein:
the hydrogen tank system (10) comprises several tanks (12-17), which have the measuring points,
the expected course (30) is determined for each of the tanks (12-17), and
the throttling losses (11) are limited to certain pipes within the hydrogen tank system (10) on the basis of the measuring points affected by the deviation (33).

3. The method (40) according to claim 2,
wherein:
the initial temperature and fill level of the tanks (12-17) are determined before access and
the expected course (30) is determined depending on the initial temperature and the fill level.

4. The method (40) according to claim 2,
wherein:
access is an emptying of the hydrogen tank system (10) and
the determination of the expected course (30) is based on a mass flow during emptying and an ambient temperature of the hydrogen tank system (10).

5. The method (40) according to claim 2,
wherein:
after containment, the tanks (12-17) affected by the throttling losses (11) are at least temporarily taken out of operation.

6. The method (40) according to claim 1,
wherein:
the detected throttling losses (11) are noted in a fault memory or
the detected throttling losses (11) are displayed to an operator of the hydrogen tank system (10).

7. The method (40) according to claim 1, wherein:
the deviation (33) is detected if the pressure or temperature (31) falls below a predetermined threshold value after a certain duration (32) of access, or
the deviation (33) is detected if the pressure or temperature (31) rises or falls less than expected during access.

8. (canceled)

9. A machine-readable, computer-readable medium containing instructions that when executed by a computer cause the computer to detect throttling losses (11) in a hydrogen tank system (10), by before access to the hydrogen tank system (10), determining, at different measuring points in the hydrogen tank system (10), a course (30) of pressure and temperature (31) expected for the access without the throttling losses (11), recording the pressure and the temperature (31) at the measuring points continuously during the access, and
detecting the throttling losses (11) on a case-by-case basis of the deviation (33) of the pressure or the temperature (31) from the expected course (30).

10. A device (50) configured to perform the method (40) according to claim 1.
